(19) United States
(12) Patent Application Publication
(10) Pub. No.: US 2026/0317464 A1
(43) Pub. Date: Oct. 15, 2026

(54) AQUEOUS DISPERSION FOR CEMENTITIOUS WATERPROOFING MATERIAL AND THE USE THEREOF

(71) Applicant: BASF SE, Ludwigshafen am Rhein (DE)

(72) Inventors: Zheng Nan YANG, Shanghai (CN); Ya Xian ZHAI, Shanghai (CN); Michael DIETZSCH, Ludwigshafen am Rhein (DE); Thomas GOETZ, Ludwigshafen am Rhein (DE); Zhong ZENG, Shanghai (CN); Sheng Xian WANG, Shanghai (CN)

(21) Appl. No.: 19/477,886

(22) PCT Filed: Apr. 23, 2024
(86) PCT No.: PCT/CN2024/089278

§ 371 Date: Oct. 23, 2025

(30) Foreign Application Priority Data
Apr. 24, 2023 (WO) PCT/CN2023/090315

(51) Int. Cl. C08F 212/08; C04B 24/26; C04B 103/65; C08F 2/24

(52) U.S. Cl. CPC C08F 212/08; C04B 24/2676; C08F 2/24; C04B 2103/65; C08F 2800/20

(57) ABSTRACT

The present invention is directed to an aqueous dispersion, a redispersible polymer powder produced from the aqueous dispersion, a method for preparing waterproofing material by mixing the aqueous dispersion or the redispersible polymer powder with at least one hydraulic binder and/or a filler, use of the aqueous dispersion or the redispersible polymer powder for preparing waterproofing material, a waterproofing material comprising the aqueous dispersion or the redispersible polymer powder. The waterproofing material shows low Tg, high adhesion strength to the concrete substrate, good tensile strength and elongation at break.

### TECHNICAL FIELD

The present invention is directed to an aqueous dispersion, a redispersible polymer powder produced from the aqueous dispersion, a method for preparing waterproofing by mixing the aqueous dispersion or the redispersible polymer powder with at least one hydraulic binder and/or a filler, use of the aqueous dispersion or the redispersible polymer powder in waterproofing material, a waterproofing material comprising the aqueous dispersion or the redispersible polymer powder.

### BACKGROUND

Typically, polymer dispersion modified cementitious material is widely used in the construction or building industry for sealing and protection of the surfaces of any kind of artificial or construction structures. It can provide flexible watertight membrane with a suitable polymer dispersion together with cement, sand and other inorganic fillers. The resulting membrane protects the underlying structures and prevents the penetration of water and other aqueous solutions, other non-aqueous liquids and/or gases such as carbon dioxide or sulfur dioxide. The polymer dispersion may be, for example, acrylic dispersion, ethylene-vinyl acetate dispersion, chloroprene dispersion, styrene-butadiene dispersion, acrylonitrile-butadiene dispersion, natural rubber dispersion or the like. Among them, styrene-acrylate dispersion is mostly used in this area. However, the adhesion strength is usually not high enough when the polymer membrane is designed with high flexibility. CN 111269348 describes compositions for preparing carboxyl styrene-butadiene latex which comprise a combination of styrene, butadiene, butyl acrylate and octyl acrylate. High amounts of acrylates are used in the composition which makes the latex suitable for use to prepare concrete. The use of the latex for preparing waterproofing coating material for cement matrix is not described or suggested.

CN 101139413 describes compositions for preparing waterproofing coating material which comprise a combination of styrene, butadiene or isoprene, and butyl acrylate. However, the balance of low Tg and good elongation at break of the waterproofing coating material is problematic. There is a great demand to achieve a kind of polymer dispersion from which waterproofing material could be obtained with low Tg, high adhesion to concrete substrate, good tensile strength and elongation at break.

### SUMMARY DESCRIPTION

The object of the present invention is to provide a dispersion which results in a cementitious waterproofing membrane with high adhesion strength to the concrete substrate, good tensile strength and elongation at break.

It has been surprisingly found that the object is achieved by an aqueous dispersion, a redispersible polymer powder produced from the aqueous dispersion, a method for preparing waterproofing material by mixing the aqueous dispersion or the redispersible polymer powder with at least one hydraulic binder and/or a filler, use of the aqueous dispersion or the redispersible polymer powder in waterproofing material, a waterproofing material comprising the aqueous dispersion or the redispersible polymer powder, and at least one hydraulic binder and/or a filler.

In one aspect, the present invention is directed to an aqueous dispersion, comprising
i) a copolymer prepared by polymerization of ethylenically unsaturated monomers comprising styrene, conjugated dienes, itaconic and/or (meth)acrylic acid esters, and at least one ethylenically unsaturated functional monomer; wherein the ethylenically unsaturated functional monomer is selected from the group consisting of an ethylenically unsaturated monomer having an acid group and/or the corresponding anion thereof, an ethylenically unsaturated monomer having an amino, amido, ureido or N-heterocyclic group and/or protonated on the nitrogen, or alkylated ammonium derivatives thereof, and an ethylenically unsaturated monomer having a keto group; and
ii) an emulsifier system, wherein the emulsifier system comprises at least one nonionic emulsifier, anionic emulsifier, or cationic emulsifier.

In another aspect, the present invention is directed to a redispersible polymer powder produced from the aqueous dispersion.

In another aspect, the present invention is directed to a method for preparing waterproofing material, comprising at least one step of mixing the aqueous dispersion or the redispersible polymer powder with at least one hydraulic binder and/or a filler.

In another aspect, the present invention is directed to use of the aqueous dispersion or the redispersible polymer powder in waterproofing material.

In another aspect, the present invention is directed to a waterproofing material comprising the aqueous dispersion, and at least one hydraulic binder and/or a filler.

In another aspect, the present invention is directed to a waterproofing material comprising the redispersible polymer powder, and at least one hydraulic binder and/or a filler.

In another aspect, the present invention is directed to a waterproofing material (1K) or a waterproofing material (2K).

### DETAILED DESCRIPTION

The present invention would be illustrated in a detailed way hereinafter.

In one aspect, the present invention is directed to an aqueous dispersion, comprising
i) a copolymer prepared by polymerization of ethylenically unsaturated monomers comprising styrene, conjugated dienes, itaconic and/or (meth)acrylic acid esters, and at least one ethylenically unsaturated functional monomer; wherein the ethylenically unsaturated functional monomer is selected from the group consisting of an ethylenically unsaturated monomer having an acid group and/or the corresponding anion thereof, an ethylenically unsaturated monomer having an amino, amido, ureido or N-heterocyclic group and/or protonated on the nitrogen, or alkylated ammonium derivatives thereof, and an ethylenically unsaturated monomer having a keto group; and
ii) an emulsifier system, wherein the emulsifier system comprises at least one nonionic emulsifier, anionic emulsifier, or cationic emulsifier.

Styrene is present in an amount of about 20 to 70% by weight, preferably 30 to about 60% by weight, more preferably 35 to 60% by weight, in each case based on the total weight of the monomers.

Conjugated dienes are present in an amount of about 20 to 60% by weight, preferably about 25 to 50% by weight, in each case based on the total weight of the monomers.

In a preferred embodiment, the conjugated dienes are butadiene.

Itaconic and/or (meth)acrylic acid ester is present in an amount of about 0.1 to 50%, preferably about 0.1 to 40% by weight, in each case based on the total weight of the monomers.

The itaconic and/or (meth)acrylic acid esters may be C₁ to C₁₈, preferably C₁ to C₁₀, more preferably C₁ to C₈ alkyl ester of itaconic and/or (meth)acrylic acid, such as methyl ester, ethyl ester, n-propyl ester, iso-propyl ester, n-butyl ester, sec-butyl ester, iso-butyl ester, n-amyl ester, iso-amyl ester, n-hexyl ester, iso-hexyl ester, heptyl ester, octyl ester, 2-ethylhexyl ester, nonyl ester, decyl ester, undecyl ester, dodecyl ester, tridecyl ester, tetradecyl ester, pentadecyl ester, hexadecyl ester, heptadecyl ester, octadecyl ester, 2-hydroxyethyl acrylate, 2-hydroxyethyl methacrylate (HEMA), 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate or 4-hydroxybutyl methacrylate; or C₅ to C₁₈, preferably C₅ to C₁₀, more preferably C₅ to C₈ cycloalkyl ester of itaconic and/or (meth)acrylic acid, such as cyclopentyl ester, cyclohexyl ester, cycloheptyl ester, or cyclooctyl ester; preferably methyl ester, ethyl ester, n-propyl ester, iso-propyl ester, n-butyl ester, sec-butyl ester, iso-butyl ester, n-amyl ester, iso-amyl ester, n-hexyl ester, iso-hexyl ester, heptyl ester, octyl ester, or 2-ethylhexyl ester; more preferably methyl ester, ethyl ester, n-propyl ester, iso-propyl ester, n-butyl ester, sec-butyl ester, iso-butyl ester, or 2-ethylhexyl ester.

In a preferred embodiment, the itaconic and/or (meth)acrylic acid esters are selected from the group of n-butyl acrylate, 2-ethylhexyl acrylate (EHA), methyl methacrylate (MMA) and hydroxyethyl methacrylate.

The itaconic and/or (meth)acrylic acid esters are typically produced by esterification of itaconic and/or (meth)acrylic acid with alkanol, or by transesterification of itaconic and/or (meth)acrylic acid with alkanol.

Alkanols can be produced on large scale by fermentation from a variety of renewable feedstocks, including corn, wheat, sorghum, barley, and sugar cane, in particular from cellulose containing raw material and thus from biological sources or renewable raw materials, respectively. Therefore, including itaconic and/or (meth)acrylic acid esters into the aqueous dispersion significantly increases the amount of bio-carbon in the aqueous dispersion and thereby reduces the demand of fossil carbon and, hence, the CO₂ demand of the production of the aqueous dispersion. In particular, the amount of carbon of biological origin of at least 10 mol-%, in particular at least 15 mol-% or at least 20 mol-% or higher, e.g., 30 mol-% or 40 mol-% or higher can be achieved.

It is also possible that at least part of the educts used to synthesize bio-based itaconic and/or (meth)acrylic acid esters from renewable raw materials according to the mass balance approach. Accordingly, in addition to fossil feeds, also renewable feeds such as bio-naphtha (as e.g., described in EP 2 290 045 A1 or EP 2 290 034 A1) enter the chemical production system, such as a steam cracker. The renewable feeds are converted into products along the chemical value chain. The content of renewable material of these products is defined by the mass balance approach and can be allocated to these products.

The term “bio-carbon” indicates that the carbon is of biological origin and comes from a biomaterial/renewable resource. The content in bio-carbon and the content in biomaterial are expressions that indicate the same value. A material of renewable origin or biomaterial is an organic material wherein the carbon comes from the CO₂ fixed recently (on a human scale) by photosynthesis from the atmosphere. A biomaterial (Carbon of 100% natural origin) has an isotopic ratio ¹⁴C/¹²C greater than 10⁻¹², typically about 1.2×10⁻¹², while a fossil material has a zero ratio. Indeed, the isotopic ¹⁴C is formed in the atmosphere and is then integrated via photosynthesis, according to a time scale of a few tens of years at most. The half-life of the ¹⁴C is 5,730 years. Thus, the materials coming from photosynthesis, namely plants in general, necessarily have a maximum content in isotope ¹⁴C. The determination of the content of biomaterial or of bio-carbon can be carried out in accordance with the standards ASTM D 6866-12, the method B (ASTM D 6866-06) and ASTM D 7026 (ASTM D 7026-04).

The copolymer prepared by polymerization of ethylenically unsaturated monomers of the present invention may comprise a small amount of ethylenically unsaturated functional monomer having one unsaturated double bond and a further reactive group susceptible to a post-crosslinking reaction, including monoethylenically unsaturated monomers containing a keto group, such as acetoacetoxyethyl acrylate, acetoacetoxypropyl methacrylate, acetoacetoxybutyl methacrylate, acetoacetoxyethyl methacrylate, diacetoneacrylamide (DAAM) and diacetonemethacrylamide.

The ethylenically unsaturated functional monomer is present in an amount of about 0.01 to about 5% by weight, preferably about 0.05 to about 4% by weight, more preferably about 0.1 to about 3.5% by weight, in each case based on the total weight of the monomers.

The ethylenically unsaturated functional monomer is selected from the group consisting of an ethylenically unsaturated monomer having an acid group and/or the corresponding anion thereof, an ethylenically unsaturated monomer having an amino, amido, ureido or N-heterocyclic group and/or protonated on the nitrogen, or alkylated ammonium derivatives thereof, and an ethylenically unsaturated monomer having a keto group, preferably from acrylic acid, methacrylic acid, maleic acid, fumaric acid, itaconic acid, acrylamide, meth acrylamide, hydroxyl ethyl acrylamide and their derivatives, vinylsulfonic acid, 2-acrylamido-2-methyl-1-propanesulfonic acid, styrenesulfonic acid, its water soluble salts, acetoacetoxyethyl acrylate, acetoacetoxypropyl methacrylate, acetoacetoxybutyl methacrylate, 2-acetoacetoxy-ethylmethacrylate (AAEM), diacetoneacrylamide (DAAM) and diacetonemethacrylamid, and combinations thereof; more preferably the ethylenically unsaturated functional monomer comprises at least one of acrylamide, meth acrylamide, and their derivatives, 2-acrylamido-2-methyl-1-propanesulfonic acid, and its water soluble salts, especially their sodium salts, potassium salts or ammonium salts.

The preparation of the copolymer is in principle familiar to the person skilled in the art and can be carried out, for example, by free-radical polymerization, bulk polymerization, emulsion polymerization, solution polymerization, precipitation polymerization or suspension polymerization of the monomers, although aqueous emulsion polymerization is particularly preferred. It is therefore advantageous according to the invention for the copolymer to be dispersed in an aqueous medium, i.e. to be used in the form of an aqueous emulsion.

The preparation of copolymer in aqueous media has been described in large numbers of references. The aqueous emulsion polymerization of the monomers is therefore well known to the person skilled in the art [see, for example, Emulsion polymerization in Encyclopedia of Polymer Science and engineering, Vol. 8, p. 659 ff. (1987)].

The aqueous emulsion polymerization is usually carried out by dispersing the monomers in an aqueous medium, usually with the use of dispersing assistants, such as surfactants and/or protective colloids, and with the use of at least one water-soluble free-radical polymerization initiator.

The aqueous emulsion polymerization may be carried out by first adding the total amount of monomers and the initiator before initiating the polymerization. However, it is also possible, optionally, to initially charge only a portion of the monomers in the aqueous reaction medium before initiating the polymerization and then, after initiating the polymerization, to charge the entire or remaining amount under the polymerization conditions during the free-radical emulsion polymerization, continuously at a constant or varying flow rate, or discontinuously. The monomers can be metered in as individual streams, as a homogeneous or heterogeneous (partial) mixture, or as a monomer emulsion. Advantageously, the monomers are metered in as a mixture.

The copolymer used in the invention is obtained in the form of its aqueous emulsion by the simultaneous use of a dispersing assistant which maintains the monomer droplets and the produced polymer particles in a dispersed state in the aqueous medium and ensures the stability of the produced aqueous emulsion. As dispersing assistants, protective colloids and emulsifiers are considered which are customarily used for carrying out free-radical aqueous emulsion polymerization.

Suitable protective colloids are, for example, polyvinyl alcohols, polyalkylene glycols, alkali metal salts of polyacrylic acids and polymethacrylic acids; gelatin derivatives; or acrylic acid-, methacrylic acid- or maleic anhydride-containing homopolymers and copolymers, copolymers containing 2-acrylamido-2-methyl-1-propanesulfonic acid and/or 4-styrenesulfonic acid and alkali metal salts thereof, and also N-vinylpyrrolidone, N-vinylcaprolactam, N-vinylcarbazole, 1-vinylimidazole, 2-vinylpyridine, 4-vinylpyridine, acrylamide, meth acrylamide, amino-containing acrylates, methacrylates, acrylamide and/or meth acrylamide homopolymers and copolymers. Further suitable protective colloids are described for example in Houben-Weyl, Methoden der organischen Chemie, volume XIV/1, Makromolekulare Stoffe, Georg-Thieme-Verlag, Stuttgart, 1961, pages 411 to 420. The protective colloids preferably used as dispersing assistants are advantageously used in a total amount of 0.005 to 10% by weight, preferably 0.01 to 5% by weight and more particularly 0.1 to 4% by weight, based in each case on the total amount of the monomers.

The polymerization is carried out in the presence of initiator which form radicals under the reaction conditions. The initiator may be peroxides or else azo compounds. Redox initiator systems are also contemplated, of course.

Peroxides used may in principle be inorganic peroxides and/or organic peroxides. Examples of suitable inorganic peroxides include hydrogen peroxide and also persulfates, such as the mono- or di-alkali metal or -ammonium salts of persulfuric acid, examples being its mono- and di-sodium, -potassium or -ammonium salts, such as sodium persulfate, potassium persulfate and ammonium persulfate. Examples of suitable organic peroxides are alkyl hydroperoxides such as tert-butyl hydroperoxide, aryl hydroperoxides such as p-menthyl hydroperoxide or cumene hydroperoxide, dialkyl or diaryl peroxides, such as di-(tert-butyl) peroxide, and benzoyl peroxide or di-cumene peroxide, and peroxy esters.

Azo compounds used are essentially 2,2′-azobis(isobutyronitrile), 2,2′-azobis(2-methylbutyronitrile), 2,2′-azobis(2,4-dimethylvaleronitrile), 2,2′-azobis(N,N′-dimethyleneisobutyroamidine) dihydrochloride and 2,2′-azobis(amidinopropyl) dihydrochloride.

Redox initiator systems are combined systems composed of at least one organic or inorganic reducing agent and at least one oxidizing agent. Oxidizing agents contemplated for redox initiator systems are essentially the peroxides stated above. As corresponding reducing agents it is possible to use compounds of sulfur in a low oxidation state, such as alkali metal sulfites, as for example potassium and/or sodium sulfite, alkali metal hydrogensulfites, as for example potassium and/or sodium hydrogensulfite, alkali metal metabisulfites, as for example potassium and/or sodium metabisulfite, acetone bisulfite, formaldehyde-sulfoxylates, as for example potassium and/or sodium formaldehyde-sulfoxylate, alkali metal salts, especially potassium and/or sodium salts, of aliphatic sulfinic acids, and alkali metal hydrogensulfides, such as potassium and/or sodium hydrogensulfide, for example, salts of polyvalent metals, such as iron(II) sulfate, iron(II) ammonium sulfate, iron(II) phosphate, enediols, such as dihydroxymaleic acid, benzoin and/or ascorbic acid, and also reducing saccharides, such as sorbose, glucose, fructose and/or dihydroxyacetone.

Preferred initiators are peroxy type initiators such as hydrogen peroxide, tert-butyl hydroperoxide, di-(tert-butyl) peroxide, benzoyl peroxide, peroxy esters; and persulfates such as sodium persulfate, potassium persulfate and ammonium persulfate; and azo type initiators.

The polymerization takes place in general by using 0.1 to 5% by weight of the radical initiator, preferably 0.5 to 4% by weight of the radical initiator, based in each case on the total amount of the monomers.

Initiation of the polymerization reaction refers to the start of the polymerization reaction of the monomers present in the polymerization vessel through decomposition of the radical initiator. The polymerization starts, for example, when the polymerization mixture contains monomers and inorganic peroxide and reaches a temperature in the range from 60° C. to 125° C., preferably from 70° C. to 100° C., more preferably from 80° C. to 95° C.

In addition to the above components, a molecular weight regulator may optionally be used during the emulsion polymerization to reduce/correct the molecular weight of the copolymer obtainable by the polymerization. It is possible to use predominantly aliphatic and/or aromatic halogen compounds, for example halogenated hydrocarbons, such as n-butyl chloride, n-butyl bromide, n-butyl iodide, methylene chloride, ethylene chloride, chloroform, bromoform, bromotrichloromethane, dibromomethylene chloride, carbon tetrachloride, carbon tetrabromide, benzyl chloride, benzyl bromide, organosulfur compounds, such as aliphatic primary, secondary or tertiary mercaptans, for example ethylmercaptan, n-propylmercaptan, 2-propylmercaptan, n-butylmercaptan, 2-methyl-2-propylmercaptan, n-pentylmercaptan, 2-pentylmercaptan, 3-pentylmercaptan, 2-methyl-2-butylmercaptan, 3-methyl-2-butylmercaptan, n-hexylmercaptan, 2-hexylmercaptan, 3-hexylmercaptan, 2-methyl-2-pentylmercaptan, 3-methyl-2-pentylmercaptan, 4-methyl-2-pentylmercaptan, 2-methyl-3-pentylmercaptan, 3-methyl-3-pentylmercaptan, 2-ethylbutylmercaptan, 2-ethyl-2-butylmercaptan, n-heptylmercaptan and its isomer compounds, n-octylmercaptan and its isomer compounds, n-nonylmercaptan and its isomer compounds, n-decylmercaptan and its isomer compounds, n-undecylmercaptan and its isomer compounds, n-dodecylmercaptan and its isomer compounds, n-tridecylmercaptan and its isomer compounds, substituted mercaptans, e.g. 2-hydroxyethylmercaptan, tertiary dodecyl mercaptan, aromatic mercaptans such as benzenethiol, o-benzenethiol, m- or p-methylbenzenethiol, and all others described in Polymerhandbook, 3rd edition, 1989, J. Brandrup and E. H. Immergut, John Wiley & Sons, section II, sulfur compounds from pages 133 to 141, as well as aliphatic and/or aromatic aldehydes such as acetaldehyde, propionaldehyde and/or benzaldehyde, unsaturated fatty acids such as oleic acid, dienes with nonconjugated double bonds such as divinylmethane or vinylcyclohexane, olefins such as cyclohexene, alpha-methyl styrene and its dimer, or hydrocarbons with readily removable hydrogen atoms such as toluene.

The total amount of molecular weight regulator used during the emulsion polymerization is generally 5% by weight or less, often 3% by weight or less and often 1% by weight or less, based on the total monomers. In an embodiment, the total amount of molecular weight regulator used during the emulsion polymerization is in the range from 0.1% to 5% by weight, or 0.2 to 3% by weight, based on the total monomers.

In another embodiment, the aqueous dispersion further comprises a crosslinker. Examples of crosslinker are compounds having at least two functional groups selected from oxazoline, amino, aldehyde, aminoxy, carbodiimide, aziridinyl, epoxy and hydrazide groups, derivatives or compounds bearing acetoacetyl groups.

In a preferred embodiment, the amount of crosslinker used during the emulsion polymerization is in the range from 0% to 10% by weight, or 0 to 7% by weight, based on the total monomers.

When it is desired to set the particle size of the polymer particles obtainable by the aqueous emulsion polymerization to a specific value, polymer seeds are used in particular (see, for example, U.S. Pat. Nos. 2,520,959A and 3,397,165A). The seed may be used in an amount of from about 0.01 to about 5% by weight, usually from about 0.05 to about 3% by weight and frequently from about 0.1 to about 2.5% by weight of polymer seeds, based in each case on the total amount of the monomers.

One type of polymer seed used is in particular polymer seed particles which have a particle size of 60 nm or less, usually from 5 nm to 50 nm and usually from 15 nm to 35 nm, determined by light scattering.

When polymer seeds are used, it is advantageous to use exogenous polymer seeds. Unlike insitu polymer seeds, which are prepared in the reaction vessel before the actual emulsion polymerization reaction begins and which have the same monomer composition as the polymer prepared by the subsequent free-radically initiated aqueous emulsion polymerization reaction, exogenous polymer seeds are polymer seeds which are prepared in a separate reaction step and whose monomer composition differs from the polymer prepared by the aqueous emulsion polymerization reaction, although this means only different monomers, or monomer compositions having different compositions, for preparing exogenous polymer seeds and for preparing the copolymer. The preparation of exogenous polymer seeds is well known to those skilled in the art and is generally accomplished by introducing as an initial charge into a reaction vessel having a relatively small amount of monomer and a relatively large amount of surfactant, and by addition of a sufficient amount of polymerization initiator at the reaction temperature.

According to the invention, it is preferred to use exogenous polymer seeds having a glass transition temperature of more than 50° C., usually from 60 to 100° C. and often from 70° C. to 100° C. Particularly preferred are polystyrene or polymethylmethacrylate polymer seeds.

The entire amount of exogenous polymer seeds may be charged first to the polymerization reaction vessel. It is also possible to include only a portion of the exogenous polymer seeds in the initial charge being added to the polymerization vessel and to add monomers along with the remainder during the polymerization. However, if desired, the entire amount of polymer seed may also be added during the polymerization. Preferably, the entire amount of exogenous polymer seeds is first charged to the polymerization vessel prior to initiating the polymerization reaction.

The polymerization reaction may be carried out at a temperature of 60° C. to 125° C., preferably from 70° C. to 100° C., more preferably from 80° C. to 95° C. for a period of 1 to 10 hours, preferably 2 to 8 hours, more preferably 4 to 6 hours.

The glass transition temperature Tg of the copolymer obtainable by emulsion polymerization can in principle be in the range from −30 to 5° C., preferably-20 to 0° C. The glass transition temperature Tg is understood here to mean the actual glass transition temperature which is the midpoint temperature determined by means of Differential Scanning calorimetry (DSC) according to ASTM D3418-82 [see also Ullmann's Encyclopedia of Industrial Chemistry, p. 169, Verlag Chemistry, Weinheim, 1992].

A theoretical glass transition temperature can be calculated from the monomers used in the emulsion polymerization. The theoretical glass transition temperatures are usually calculated from the monomers by the Fox equation:

1/Tg^{t}=xₐ/Tgₐ+x_{b}/Tg_{b}+ . . . xₙ/Tgₙ,

In this equation xₐ, x_{b}, . . . xₙ are the mass fractions of the monomers a, b, . . . n and Tgₐ, Tg_{b}, . . . Tgₙ are the actual glass transition temperatures in Kelvin of the homopolymers synthesized from only one of the monomers 1, 2, . . . n at a time. The Fox equation is described by T. G. Fox in Bull. Am. Phys. Soc. 1956, 1, page 123 and as well as in Ullmann's Encyclopädie der technischen Chemie [Ullmann's Encyclopedia of Industrial Chemistry], vol. 19, p. 18, 4th ed., Verlag Chemie, Weinheim, 1980. The actual Tg values for the homopolymers of most monomers are known and listed, for example, in Ullmann's Encyclopädie der technischen Chemie [Ullmann's Encyclopedia of Industrial Chemistry], 5th ed., vol. A21, p. 169, Verlag Chemie, Weinheim, 1992. Further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004.

Usually, the theoretical glass temperature Tg^{t} calculated according to Fox as described herein and the experimentally determined glass transition temperature as described herein are similar or even same and do not deviate from each other by more than 5 K, in particular they deviate not more than 2 K. Accordingly, both the actual and the theoretical glass transition temperatures of the copolymer can be adjusted by choosing proper monomers Ma, Mb . . . Mn and their mass fractions xₐ, x_{b}, . . . xₙ in the monomers so to arrive at the desired glass transition temperature Tg(1) and Tg(2), respectively. It is common knowledge for a skilled person to choose the proper amounts of monomers Ma, Mb . . . Mn for obtaining a copolymer and/or copolymer phase with the desired glass transition temperature.

After the polymerization, the residue content of the monomers is generally removed in order to deodorize, such as by chemical and/or physical processes. The typical chemical and/or physical deodorization processes are known to the person skilled in the art [see, for example, EP-A771328, DE-A19624299, DE-A19621027, DE-A19741184, DE-A19741187, DE-A19805122, DE-A19828183, DE-A19839199, DE-A19840586 and 19847115]. The chemical deodorization process may be carried out by adding a further radical initiator from the group of the abovementioned initiators to the reaction mixture, or to prolong the addition thereof, and carrying out what is called an “Post-polymerization”, in other words a polymerization for achieving a conversion of 95 to 99%. It is sufficient in the majority of cases for the reaction mixture to be stirred for 0.1 to 3 hours, preferably 0.5 to 2 hours, more preferably 0.5 to 1 hour, at the polymerization temperature, after the end of the addition of monomer. The physical deodorization process may be carried out by stripping with steam or inert gas, in order to reduce the content of the monomers.

The solid content is adjusted to the desired value by dilution or concentration, or the resulted aqueous emulsion is mixed with further conventional additives, for example bactericides, foam-modifying additives or viscosity-modifying additives.

The solid content was determined by drying a defined amount of the aqueous dispersion (about 2 g) to constant weight in an aluminum crucible having an internal diameter of about 5 cm at 130° C. in a drying cabinet (2 hours). Two separate measurements were conducted. The value reported in the example is the mean of the two measurements.

The aqueous dispersion obtainable by the emulsion polymerization generally have a solid content of 10 to 70% by weight, usually 20 to 65% by weight and frequently 25 to 60% by weight, all based on the aqueous dispersion. The particle size, determined by dynamic light scattering (DLS) using a Malvern HPPS, is generally in the range of 80 to 300 nm, frequently in the range of 100 to 250 nm.

The polymerization may be carried out by firstly adding the total amount of monomers and the initiator before initiating the polymerization. However, it is also possible to charge the monomers and the initiator into the aqueous reaction medium continuously at a constant or varying flow rate. The monomers can be metered in as individual streams, as a homogeneous or heterogeneous (partial) mixture. Advantageously, the monomers are metered in as individual streams.

The process for producing the aqueous dispersion of the present disclosure may be a single stage polymerization or a multistage emulsion polymerization. In a single stage polymerization, the overall composition of the monomers, which are fed to the polymerization reaction under polymerization conditions, remains the same or almost the same, while in a multistage emulsion polymerization the overall composition of the monomers, which are fed to the polymerization reaction under polymerization conditions, is altered at least once, in particular such that the theoretical glass transition temperature of the resulting polymer formed in one stage differs from the theoretical glass transition temperature of the resulting polymer formed in another stage by at least 10° C., in particular by at least 20° C. or at least 40° C.

In a particular group of embodiments, the process of the invention is performed as a 2-stage emulsion polymerization, i.e. the composition of the monomers, which are fed to the polymerization reaction under polymerization conditions, is amended once, or as a 3- or 4-stage emulsion polymerization, i.e. the composition of the monomers, which are fed to the polymerization reaction under polymerization conditions, is amended twice or trice.

The emulsifier system comprises at least one nonionic emulsifier, anionic emulsifier, or cationic emulsifier.

The nonionic emulsifier in the emulsifier system is selected from the group consisting of ethoxylated mono-, di-, and tri-alkylphenols and ethoxylated fatty alcohols or alkylphenol/fatty alcohol with polymerizable moiety. Examples thereof are those available from BASF SE Trademark Lutensol® A (C₁₂C₁₄ fatty alcohol ethoxylate, EO degree: 3 to 8), Trademark Lutensol® AO (C₁₃C₁₅ oxo-alcohol ethoxylate, EO degree: 3 to 30), Trademark Lutensol® AT (C₁₆C₁₈ fatty alcohol ethoxylate, EO degree: 11 to 80), Trademark Lutensol® ON (C₁₀ oxo-alcohol, EO degree: 3 to 11), Trademark Lutensol® TO (C₁₃ oxo-alcohol, EO degree: 3 to 20), Trademark Disponil® LDBS (sodium salts of linear C₁₀C₁₃-alkyl benzene sulfonate) and Trademark Disponil®FES (sodium salts of fatty alcohol ethersulfate).

The anionic emulsifier in the emulsifier system is selected from the group consisting of alkali metal salts and ammonium salts of alkyl sulfates, of sulfuric monoesters with ethoxylated alkanols and with ethoxylated alkylphenols, of alkylsulfonic acids, and of alkylarylsulfonic acids, or alkylphenol/fatty alcohol sulphate with polymerizable moiety and a combination thereof; Suitable anionic emulsifiers also include compounds of the general formula (I),

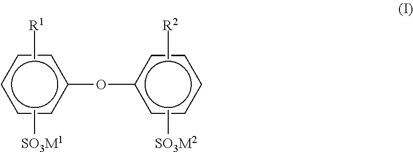

wherein R¹ and R² is H atom or C₁ to C₂₄ alkyl radical, with the proviso that R¹ and R² are not H at the same time, and M¹ and M² may be an alkali metal ion and/or an ammonium ion. In the general formula (I), R¹ and R² preferably have 6 to 18 carbon atoms, more particularly 6 carbon atoms. M¹ and M² preferably is sodium, potassium or ammonium, sodium. Of particular advantage M¹ and M² are all sodium, R¹ is a branched alkyl group of 12 carbon atoms and R² is H atom or R¹.

And the cationic emulsifier in the emulsifier system is selected from the group consisting of positively charged amines and quaternary ammonium compounds with polymerizable moiety. The polymerizable moiety may be any moiety that could be polymerized by free radical polymerization, for example, allyl group, (meth)acrylamide group, styryl group, (meth)acrylate group or maleate group. The emulsifier with polymerizable moiety and its preparation is known from the prior art and commercially available. Suitable emulsifiers with polymerizable moiety may be, sodium 2-acrylamido-2-methyl-propyl sulfonate, sodium allyloxy hydroxylpropyl sulfonate, and ammonium allyloxy alkyl phenol polyethylene oxide sulfate. Numerous other examples are found in H. Stache, Tensid-Taschenbuch, Carl-Hanser-Verlag, Munich, Vienna, 1981 and Mccutcheon's, Emulsifiers & Detergens, MC Publishing Company, Glen Rock, 1989.

The emulsifier system is advantageously used in a total amount of 0.005 to 10% by weight, preferably 0.01 to 5% by weight and more particularly 0.1 to 4% by weight, based in each case on the total weight of the aqueous dispersion.

The obtained dispersion could be dried to obtain a redispersible polymer powder. Drying can be carried out in a conventional manner, for example by spray drying, fluidized bed drying, drum drying, flash drying, freeze drying or drying under ambient conditions.

“Redispersible” as used herein means that the particle size, as determined by dynamic light scattering, of the polymer particles after drying and redispersing in an artificial solution (alkaline aqueous solution containing: Ca²⁺ 10 mmol/L, Na⁺ 98.5 mmol/L, K⁺ 181.6 mmol/L, SO₄²⁻ 86.2 mmol/L, pH=13.1) is ≤1000 nm, preferably ≤600 nm and in particular ≤400 nm.

Therefore, the present invention is directed to a redispersible polymer powder produced from the aqueous dispersion.

The aqueous dispersion or the redispersible polymer powder could be used in waterproofing material in the building sector by mixing with at least one hydraulic binder and/or a filler. Therefore, in one embodiment, the present invention is directed to a method for preparing waterproofing material, comprising at least one step of mixing the aqueous dispersion or the redispersible polymer powder with at least one hydraulic binder and/or a filler.

The hydraulic binder maybe calcium silicate cement such as ordinary portland cement, calcium aluminate cement, calcium sulfate source, calcium sulfoaluminate cement or latent hydraulic materials such as metakaolin, calcium metasilicate, volcanic slag, volcanic tuff, trass, fly ash, blast furnace slag which are often labeled as supplementary cementitious materials (SCM) etc.

The content of the hydraulic binder may be from about 1 to 70% by weight, preferably from about 1 to about 60% by weight, more preferably from about 1 to 50% by weight, based in each case on the total weight of the waterproofing material.

The waterproofing material may further comprise fillers, additives, fibers and/or pigments.

In an embodiment, fillers comprise inorganic filler and/or organic filler. Inorganic fillers are preferred, such as gypsum, including chalk, talcum, sand, lime or silica. Organic filler such as ground rubber can also be used in the waterproofing material.

In a particular embodiment, inorganic pigments are preferred, such as white pigments like titanium dioxide (C.I. Pigment White 6), but also color pigments.

Examples of additives are flame-proofing materials; antioxidants; fungicides; accelerators such as alkali metal carbonates; retardants such as tartaric acid or citric acid; thickener; foam inhibitors; preservatives; wetting agents; rheology modifying agents; vulcanizing agents; adhesion aids, etc. The thickener may be associative thickeners. Associative thickeners are generally hydrophobically modified polymer thickeners having hydrophilic and hydrophobic structural units side by side. Important typical members of this class of thickeners are the polyurethane thickeners (=hydrophobically modified, ethoxylated urethanes HEUR or PU thickeners) and the HASE thickeners (=hydrophobically modified alkali-swellable emulsions).

In one embodiment, the waterproofing material may comprise 10-40% by weight, preferably 15-30% by weight, most preferred 18-20% by weight of the redispersible polymer powder, based on the weight of the waterproofing material.

In another embodiment, the waterproofing material may comprise 10-80% by weight, preferably 20-70% by weight of an aqueous dispersion, based on the weight of the waterproofing material.

In one embodiment, the waterproofing material (1K) comprises
(i) 1-50% by weight hydraulic binder,
(ii) 40-77% by weight filler,
(iii) 10-40% by weight, preferably 15-30% by weight, most preferred 18-20% by weight of the redispersible polymer powder, and
(iv) 0-5% by weight one or more additives,
in each case based on the weight of the waterproofing material (1K).

In another embodiment, the waterproofing material (2K) comprises
(a) a dry component comprising
(i) 1-50% by weight hydraulic binder,
(ii) 40-60% by weight filler, and
(iv) 0-5% by weight one or more additives,
in each case based on the weight of the total dry component, and
(b) a wet component comprising
(i) 90-100% by weight of an aqueous dispersion, and
(ii) optionally one or more additives,
in each case based on the weight of the total wet component,
and wherein the ratio of dry component (a) to wet component (b) is in the range of 4:1 to 1:2.

In a particular embodiment, the waterproofing material comprises the following components:

| | Weight |
|---|---|
| Components | [g] |
| OPC (Milke CEM I 52.5N) | 250 |
| Sand F 36 | 646 |
| Limestone (Omyacarb 15 GU) | 100 |
| Thickener (Rheovis HS 1980) | 0.8 |
| Defoamer (Vinapor DF 9010F) | 3.2 |
| Sum dry compound | 1000 |
| Aqueous dispersion (50%) | 499 |
| Defoamer (Foammaster SI 2213) | 1 |
| Sum wet compound | 500 |

In another particular embodiment, the waterproofing material comprises the following components:

| | Weight |
|---|---|
| Components | [g] |
| OPC (Milke CEM I 52.5N) | 40 |
| CAC (Istra 40) | 269 |
| alpha-Hemihydrate (Knauf) | 100 |
| Ca(OH)₂ | 3.6 |
| Li₂CO₃ | 1.4 |
| Citric acid | 1.5 |
| Ground Rubber (<400 μm) | 339 |
| Sand F 36 | 240 |
| Thickener (Rheovis HS 1980) | 1.5 |
| Defoamer (Vinapor DF 9010 F) | 4 |
| Sum dry compound | 1000 |
| Aqueous dispersion (50%) | 999 |
| Foammaster SI 2213 | 1 |
| Sum wet compound | 1000 |

Typically, the waterproofing material is used in the construction or building industry for sealing and protection of the surfaces of any kind of artificial or construction structures by coating such structures with the waterproofing material that after hydration and hardening form membranes. The resulting membranes protect the underlying structures and prevent the penetration of water and other aqueous solutions, other non-aqueous liquids and/or gases such as carbon dioxide or sulfur dioxide. Furthermore, the waterproofing membranes are also used beneath tiles and slabs of stone or other materials for example on balconies or terraces. In such cases the waterproofing membranes functions not only as a waterproofing membrane, but also as an adhesive and is applied directly to the concrete, masonry or other substrate surface. Further coverings of tiles and slabs are then laid thereon.

The waterproofing material is applied in one or more layers. In many cases two layers, between 0.5 and 10 mm are applied. The final waterproofing membranes have a thickness of more than 0.5 mm, particularly more than 1 mm. The waterproofing material is usually applied with brushes, swabs, trowels or sprayed.

The waterproofing material may also be utilized for producing or manufacturing stable and highly flexible waterproofing membranes. Such waterproofing membranes may optionally contain a base fabric or matrix which is coated on one or both sides with the inventive composition as a coating to form a non-permeable barrier. Such waterproofing membranes may be composed of one or more layers of each waterproofing material and/or base fabric or matrix and constitute a single or multiple ply membrane. Alternatively, the flexible waterproofing membranes may be prepared by immersing a base fabric or matrix into a bed of waterproofing material, the slurry evenly spread out whereby the slurry and base fabric or matrix combine and form a single foil or wallpaper-like element. These waterproofing membranes can be used in various construction and architectural applications. These types of membranes are generally designed for direct installation, with or without combination with any other layers or materials to provide a waterproofing barrier. The base fabric or matrix may be selected from woven, knitted or non-woven natural or polymeric fibers, glass fibers, a polymeric adhesive coating, and optionally a polymeric coating on one or both sides of the base fabric. The resulting flexible waterproofing membranes can be manufactured or prefabricated in the form of a foil or wallpaper of controlled quality and stored for further use. Such a prefabricated foil can be utilized as a wallpaper providing for example an immediate to use underground for further tiling without the need of waiting several hours of drying before tile adhesive can be applied as required for standard waterproofing slurries.

The waterproofing material of the present invention shows low Tg, high adhesion strength to the concrete substrate, good tensile strength and elongation at break.

The invention also further relates to the use of the redispersible polymer powder of the invention in a waterproofing material. It is particularly advantageous that the waterproofing material can be used in the form of dry mixes because the redispersible polymer powder of the invention has particularly good redispersibility.

More particularly, the use of the redispersible polymer powder of the invention is advantageous for the following waterproofing material, or preference is given to the following waterproofing material of the inventions: tile adhesives and watertight sealing compounds (membranes).

The present invention is further illustrated by the following embodiments and combinations of embodiments as indicated by the respective dependencies and back-references. In particular, it is noted that in each instance where a range of embodiments is mentioned, for example in the context of a term such as “The process of any of embodiments 1 to 4”, every embodiment in this range is meant to be explicitly disclosed for the skilled person, i.e. the wording of this term is to be understood by the skilled person as being synonymous to “The process of any of embodiments 1, 2, 3, and 4”.
1. An aqueous dispersion, comprising
   i) a copolymer prepared by polymerization of ethylenically unsaturated monomers comprising styrene, conjugated dienes, itaconic and/or (meth)acrylic acid esters, and at least one ethylenically unsaturated functional monomer; wherein the ethylenically unsaturated functional monomer is selected from the group consisting of an ethylenically unsaturated monomer having an acid group and/or the corresponding anion thereof, an ethylenically unsaturated monomer having an amino, amido, ureido or N-heterocyclic group and/or protonated on the nitrogen, or alkylated ammonium derivatives thereof, and an ethylenically unsaturated monomer having a keto group; and
   ii) an emulsifier system, wherein the emulsifier system comprises at least one nonionic emulsifier, anionic emulsifier, or cationic emulsifier.
2. The aqueous dispersion as defined according to embodiment 1, wherein the ethylenically unsaturated functional monomer is selected from the group consisting of acrylic acid, methacrylic acid, maleic acid, fumaric acid, itaconic acid, acrylamide, meth acrylamide, and their derivatives, vinylsulfonic acid, 2-acrylamido-2-methyl-1-propanesulfonic acid, styrenesulfonic acid, its water soluble salts, acetoacetoxyethyl acrylate, acetoacetoxypropyl methacrylate, acetoacetoxybutyl methacrylate, 2-acetoacetoxy-ethylmethacrylate (AAEM), diacetoneacrylamide (DAAM) and diacetonemethacrylamid, and combinations thereof.
3. The aqueous dispersion as defined according to embodiment 1 or 2, wherein the ethylenically unsaturated functional monomer comprises at least one of acrylamide, meth acrylamide, and their derivatives, 2-acrylamido-2-methyl-1-propanesulfonic acid, and its water soluble salts.
4. The aqueous dispersion as defined according to any of embodiments 1 to 3, wherein the ethylenically unsaturated functional monomer is in an amount of 0.01% to 5%, preferable 0.05% to 4%, and more preferable 0.1% to 3.5% by weight, based on the total amount of all monomers.
5. The aqueous dispersion as defined according to any of embodiments 1 to 4, wherein the styrene is present in an amount of 20 to 70% by weight, preferably 30 to 60% by weight, more preferably 35 to 60% by weight, in each case based on the total weight of the monomers.
6. The aqueous dispersion as defined according to any of embodiments 1 to 5, wherein the conjugated dienes are present in an amount of 20 to 7060% by weight, preferably 25 to 50% by weight, in each case based on the total weight of the monomers.
7. The aqueous dispersion as defined according to any of embodiments 1 to 6, wherein the itaconic and/or (meth)acrylic acid ester is present in an amount of 0.1 to 50%, preferably about 0.1 to about 40% by weight, in each case based on the total weight of the monomers.
8. The aqueous dispersion as defined according to any of embodiments 1 to 7, comprising
   a) 20 to 70% by weight, preferably 30 to 60% by weight, more preferably about 35 to 60% by weight styrene,
   b) 20 to 60% by weight, preferably 25 to 50% by weight, conjugated dienes,
   c) 0.1 to 50% by weight, preferable 0.1 to 40% by weight, itaconic and/or (meth)acrylic acid ester, and
   d) 0.01% to 5%, preferable 0.05% to 4%, and more preferable 0.1% to 3.5% by weight ethylenically unsaturated functional monomer,
   in each case based on the total weight of the monomers.
9. The aqueous dispersion as defined according to any of embodiments 1 to 7, comprising
   a) 20 to 70% by weight, preferably 30 to 60% by weight, more preferably 35 to 60% by weight styrene,
   b) 20 to 60% by weight, preferably 25 to 50% by weight, conjugated dienes,
   c) 0.1 to 40% by weight, itaconic and/or (meth)acrylic acid ester,
   d) 0.01% to 5% by weight, preferable 0.05% to 4% by weight, and more preferable 0.1% to 3.5% by weight ethylenically unsaturated functional monomer,
   in each case based on the total weight of the monomers,
   wherein the functional monomer comprises at least one of acrylamide, meth acrylamide, and their derivatives, 2-acrylamido-2-methyl-1-propanesulfonic acid, and its water soluble salts.
10. The aqueous dispersion as defined according to any of embodiments 1 to 7, comprising
   a) 20 to 70% by weight, preferably 30 to 60% by weight, more preferably 35 to 60% by weight styrene,
   b) 20 to 60% by weight, preferably 25 to 50% by weight, conjugated dienes,
   c) 9 to 40% by weight, itaconic and/or (meth)acrylic acid ester,
   d) 0.01% to 5% by weight, preferable 0.05% to 4% by weight, and more preferable 0.1% to 3.5% by weight ethylenically unsaturated functional monomer,
   in each case based on the total weight of the monomers,
   wherein the functional monomer is selected from (meth)acrylic acid.
11. The aqueous dispersion as defined according to any of embodiments 1 to 7, comprising
   a) 20 to 70% by weight, preferably 30 to 60% by weight, more preferably 35 to 60% by weight styrene,
   b) 20 to 60% by weight, preferably 25 to 50% by weight, conjugated dienes,
   c) 1 to 40% by weight, itaconic and/or (meth)acrylic acid ester,
   d) 0.01% to 5% by weight, preferable 0.05% to 4% by weight, and more preferable 0.1% to 3.5% by weight ethylenically unsaturated functional monomer,
   in each case based on the total weight of the monomers,
   wherein the functional monomer is selected from acrylamide, meth acrylamide, and their derivatives.
12. The aqueous dispersion as defined according to any one of embodiments 1 to 11, wherein the copolymer is obtained by free radical polymerization in the presence a molecular weight regulator.
13. The aqueous dispersion as defined according to any of embodiments 12, wherein the molecular weight regulator is selected from the group consisting of mercaptans such as n-dodecylmercaptan, tertiary dodecyl mercaptan; cyclohexene; halogenated hydrocarbons such as chloroform, bromoform, carbon tetrachloride; alpha-methyl styrene and its dimer, and terpinolene.
14. The aqueous dispersion as defined according to any of embodiments 1 to 13, further comprising a crosslinker.
15. A redispersible polymer powder produced from the aqueous dispersion as defined according to any one of embodiments 1 to 14.
16. A method for preparing waterproofing material, comprising at least one step of mixing the aqueous dispersion as claimed in any one of embodiments 1 to 14 or the redispersible polymer powder of embodiment 15 with at least one hydraulic binder and/or a filler.
17. Use of the aqueous dispersion as claimed in any one of embodiments 1 to 14 or the redispersible polymer powder of embodiment 15 in waterproofing material.
18. A waterproofing material comprising the aqueous dispersion as defined according to embodiments 1 to 14, or the redispersible polymer powder as defined according to embodiment 15, and at least one hydraulic binder.
19. A waterproofing material according to embodiment 16, wherein the content of the hydraulic binder may be from about 1 to 70% by weight, preferably from about 1 to about 60% by weight, more preferably from about 1 to 50% by weight, based in each case on the total weight of the waterproofing material.
20. A waterproofing material (1K) comprising
   (i) 1-50% by weight hydraulic binder,
   (ii) 40-77% by weight filler,
   (iii) 10-40% by weight, preferably 15-30% by weight, most preferred 18-20% by weight of the redispersible polymer powder according to embodiment 15, and
   (iv) 0-5% by weight one or more additives,
   in each case based on the weight of the waterproofing material (1K).
21. A waterproofing material (2K) comprising
   (a) a dry component comprising
   (i) 1-50% by weight hydraulic binder,
   (ii) 40-60% by weight filler, and
   (iv) 0-5% by weight one or more additives,
   in each case based on the weight of the total dry component, and
   (b) a wet component comprising
   (i) 90-100% by weight of an aqueous dispersion as defined according to embodiments 1 to 14, and
   (ii) optionally one or more additives,
   in each case based on the weight of the total wet component,
   and wherein the ratio of dry component (a) to wet component (b) is in the range of 4:1 to 1:2.
22. A waterproofing material composition according to any one of embodiments 18 to 21, wherein the hydraulic binder is selected from a calcium silicate cement such as ordinary portland cement, calcium aluminate cement, calcium sulfate source, calcium sulfoaluminate cement, and further latent hydraulic materials and combinations thereof.

The present invention would be further explained by the following examples. These, however, would not be construed to further limit the scopes set forth in the following claims.

### EXAMPLES

The materials used in the examples are present below.

| | |
|---|---|
| styrene (St) | BASF |
| Butadiene | Shell Petrochemicals |
| | Company |
| n-butyl acrylate (BA) | BASF |
| 2-ethylhexyl acrylate (EHA) | BASF |
| methyl methacrylate (MMA) | BASF |
| hydroxyethyl methacrylate (HEMA) | BASF |
| Functional Monomer (2-acetoacetoxy- | Lonza |
| ethylmethacrylate) | |
| Functional Monomer (acrylic acid) | BASF |
| Functional Monomer (acrylamide) | SNF(China) |
| | Flocculant Co, Ltd |
| Functional Monomer (methacrylic acid) | Shanghai Peiming |
| | Chemical |
| Functional Monomer | KJ Chemicals |
| (hydroxyl ethyl acrylamide) | Corporation |
| Functional Monomer (2-acrylamido- | BASF |
| 2-methyl-1-propanesulfonic acid) | |
| Functional Monomer (meth acrylamide) | BASF |
| Tertiary Dodecyl Mercaptan (TDMC) | Arkema |
| Emulsifier (Disponil FES 27) | BASF |
| Emulsifier (Disponil FES 77) | BASF |
| Emulsifier (Disponil FES 993) | BASF |
| Emulsifier (Lutensol TO 89) | BASF |
| Emulsifier (Disponil LDBS23) | BASF |
| Vorproduct SD 6772 | an aqueous polystyrene |
| | seed dispersion, |
| | solid content of 33 |
| | wt %, from |
| | BASF Advanced |
| | Chemicals Co. Ltd. |
| NaPS | (sodium persulfate) |
| | aqueous solution, 7 |
| | wt. %, ABC UNITED- |
| | INITIATORS HEFEI |
| | LIMITED COMPANY |

### Examples 1-14

The components for Example 1 through 14 are shown in Table 1. All values listed in Table 1 refer to grams.

TABLE 1

| | Example Formulation | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11* | 12* | 13* | 14* |
| St | 910 | 1020 | 760 | 920 | 960 | 1100 | 1020 | 1020 | 1020 | 1120 | 1020 | 1106 | 920 | 920 |
| Butadiene | 700 | 820 | 430 | 530 | 850 | 810 | 860 | 860 | 860 | 786 | 860 | 840 | 530 | 530 |
| BA | 324 | 100 | 760 | 100 | | | 60 | 60 | 60 | 60 | 60 | | 100 | 100 |
| EHA | | | | 400 | | | | | | | | | 400 | 400 |
| MMA | | | | | 100 | | | | | | | | | |
| HEMA | | 10 | | | | 40 | | | 80 | | | | | |
| 2-acetoace- | | | 10 | | | | | | | 20 | | | | |
| toxy-ethyl- | | | | | | | | | | | | | | |
| methacrylate | | | | | | | | | | | | | | |
| 2-acrylamido- | | | | | | | | | 4 | 4 | | | | |
| 2-methyl-1- | | | | | | | | | | | | | | |
| propane | | | | | | | | | | | | | | |
| sulfonic acid | | | | | | | | | | | | | | |
| meth | | | | | | | | 30 | | 6 | | | | |
| acrylamide | | | | | | | | | | | | | | |
| 30% | | 100 | 100 | 100 | 100 | 100 | 133.33 | | | | | 113 | 200 | 100 |
| Acrylamide | | | | | | | | | | | | | | |
| Methacrylic | 20 | 20 | 20 | 20 | 20 | 20 | | | 10 | | 20 | 20 | 20 | 60 |
| acid | | | | | | | | | | | | | | |
| Acrylic acid | | | | | | | | 20 | | 4 | | | | |
| hydroxyl ethyl | 20 | | | | | | | | | | | | | |
| acrylamide | | | | | | | | | | | | | | |
| TDMC | 25.2 | 22 | 31 | 27.4 | 13.6 | 30 | 15.4 | 15.4 | 15.4 | 15.4 | 15.4 | 30 | 27.4 | 27.4 |
| FES 27 | 74.7 | 78.49 | | 78.49 | | 78.49 | | 78.49 | | | 78.49 | 74.07 | 78.49 | 78.49 |
| FES 77 | | | | | | | 12.5 | | 31.25 | | | | | |
| FES 993 | | | 34.67 | | 34.67 | | | | | | 33.33 | | | |
| TO 89 | 20 | 20.26 | 20.26 | 20.26 | 20.26 | 20.26 | 20.26 | 20.26 | 20.26 | 20.26 | 44.44 | 20 | 20.26 | 20.26 |
| LDBS 23 | | 43.48 | | | | | | | | | | | | |
| Vorproduct | 16.75 | 18.18 | 16.97 | 36.36 | 24.24 | 24.24 | 36.36 | 33.33 | 36.36 | 24.24 | 24.24 | 36.63 | 36.36 | 36.36 |
| SD 6772 | | | | | | | | | | | | | | |
| NaPS | 257 | 257 | 257 | 257 | 257 | 257 | 257 | 257 | 257 | 257 | 257 | 257 | 257 | 257 |

*comparative examples

### Procedure

For examples 1 to 11, 13 and 14, 520 g water and seed Vorproduct SD 6772 were charged into a reactor, the temperature was raised to 85° C., then an aqueous stream was started to feed which is composed of 400 g water, Emulsifier, Functional Monomer, TDMC, styrene stream, butadiene stream, acrylate and 7% sodium persulphate stream. The reactor content was allowed to polymerize for 5 hours. Then the reaction mixture is cooled down to 60° C. 60 g water is dosed over 15 min with a constant dosing rate. The reaction mixture was stirred for another 30 min at 60° C. before cooling down to room temperature.

Example 12 was prepared in the same manner as Example 1, with the exception that no acrylate was fed.

63 g reaction mixture of each example, 0.19 g 10% thickener Rheovis AS 1125, 0.67 g defoamer Foamstar PB2706 from BASF and 2.5 g water were mixed with 50 g cement PO42.5, 30 g sand and 20 g CaCO₃ to make a homogeneous slurry with good flowability, then the slurry was brushed onto a PTFE board to make a membrane, use the same slurry on concrete board for adhesion testing. After 7 days curing, tensile strength, elongation at break and adhesion strength were tested according to China standard GB/T23445-2009 “Polymer modified cement compounds for waterproof membrane”. Crack bridging was tested according to China standard JC/T 2415-2017 “Liquid applied water impermeable products for use beneath ceramic tiling bonded with adhesives”.

### Results

The properties of the membranes from Example 1 to 14 are summarized in Table 2.

TABLE 2

| | Functional | Particle | | Tensile | Elongation | Adhesion | Crack |
|---|---|---|---|---|---|---|---|
| Exam- | Monomer | Size | Tg | strength | at break | strength | bridging |
| ple | [wt. %] | [nm] | [°C] | [MPa] | [%] | [MPa] | [mm] |
| 1 | 2 | 208 | −11.8 | 1.81 | 168 | 1.42 | 0.75 |
| 2 | 2.4 | 203 | −5.3 | 2.31 | 119 | 1.25 | 0.81 |
| 3 | 2.8 | 214 | −8.9 | 2.27 | 127 | 1.31 | 0.85 |
| 4 | 2.4 | 159 | −13.9 | 2.01 | 143 | 1.1 | 0.82 |
| 5 | 2.5 | 189 | −10.2 | 1.98 | 167 | 1.19 | 1.03 |
| 6 | 2.4 | 192 | −6.9 | 2.23 | 110 | 1.41 | 0.75 |
| 7 | 1.9 | 161 | −10.5 | 2.32 | 117 | 1.16 | 0.85 |
| 8 | 2.5 | 165 | −9.8 | 1.92 | 106 | 1.31 | 0.81 |
| 9 | 0.7 | 158 | −10.1 | 1.89 | 167 | 1.08 | 1.13 |
| 10 | 1.7 | 188 | −6.2 | 2.2 | 147 | 1.38 | 1.15 |
| 11 | 1 | 187 | −8.2 | 2.16 | 43.7 | 1.19 | 0.63 |
| 12 | 2.6 | 161 | −10.1 | 4.21 | 38.7 | 0.72 | 0.53 |
| 13 | 4 | 175 | −6.3 | 3.5 | 72 | 1.2 | 0.63 |
| 14 | 4.5 | 153 | −7.1 | No work- | No work- | No work- | No work- |
| | | | | ability | ability | ability | ability |

It can be seen that the overall properties of the inventive dispersions (Examples 1-10) meet the requirement of balancing the adhesion strength and flexibility. Examples 11 to 14 are comparative examples. Dispersion using methacrylic acid as the only functional monomer (Example 11) has poor crack bridging capability and elongation at break. Dispersions comprising no acrylates (Example 12) have lower elongation at break, adhesive strength and crack bridging capability. Dispersions comprising higher amounts of functional monomers (Examples 13 and 14) have lower elongation at break and crack bridging capability.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1.-22. (canceled)

23. An aqueous dispersion, comprising
i) a copolymer prepared by polymerization of ethylenically unsaturated monomers comprising styrene, conjugated dienes, itaconic or (meth)acrylic acid esters, and at least one ethylenically unsaturated functional monomer; wherein the ethylenically unsaturated functional monomer is selected from the group consisting of an ethylenically unsaturated monomer having an acid group or the corresponding anion thereof, an ethylenically unsaturated monomer having an amino, amido, ureido or N-heterocyclic group or protonated on the nitrogen, or alkylated ammonium derivatives thereof, and an ethylenically unsaturated monomer having a keto group; and
ii) an emulsifier system, wherein the emulsifier system comprises at least one nonionic emulsifier, anionic emulsifier, or cationic emulsifier.

24. The aqueous dispersion as defined according to claim 23, wherein the ethylenically unsaturated functional monomer is selected from the group consisting of acrylic acid, methacrylic acid, maleic acid, fumaric acid, itaconic acid, acrylamide, meth acrylamide, and their derivatives, vinylsulfonic acid, 2-acrylamido-2-methyl-1-propanesulfonic acid, styrene sulfonic acid, its water soluble salts, acetoacetoxyethyl acrylate, acetoacetoxypropyl methacrylate, acetoacetoxybutyl methacrylate, 2-acetoacetoxy-ethylmethacrylate (AAEM), diacetoneacrylamide (DAAM) and diacetonemethacrylamid, and combinations thereof, optionally wherein the ethylenically unsaturated functional monomer comprises at least one of acrylamide, meth acrylamide, and their derivatives, 2-acrylamido-2-methyl-1-propanesulfonic acid, and its water soluble salts.

25. The aqueous dispersion as defined according to claim 23, wherein the ethylenically unsaturated functional monomer is in an amount of 0.01% to 5% by weight, based on the total amount of all monomers.

26. The aqueous dispersion as defined according to claim 23, wherein the styrene is present in an amount of 20 to 70% by weight, based on the total weight of the monomers.

27. The aqueous dispersion as defined according to claim 23, wherein the conjugated dienes are present in an amount of 20 to 60% by weight, based on the total weight of the monomers.

28. The aqueous dispersion as defined according to claim 23, wherein the itaconic or (meth)acrylic acid ester is present in an amount of 0.1 to 50%, based on the total weight of the monomers.

29. The aqueous dispersion as defined according to claim 23, comprising
a) 20 to 70% by weight styrene,
b) 20 to 60% by weight conjugated dienes,
c) 0.1 to 50% by weight itaconic or (meth)acrylic acid ester, and
d) 0.01% to 5% by weight ethylenically unsaturated functional monomer,
in each case based on the total weight of the monomers.

30. The aqueous dispersion as defined according to claim 23, comprising
a) 20 to 70% by weight styrene,
b) 20 to 60% by weight conjugated dienes,
c) 0.1 to 40% by weight itaconic or (meth)acrylic acid ester,
d) 0.01% to 5% by weight ethylenically unsaturated functional monomer,
in each case based on the total weight of the monomers,
wherein the functional monomer is selected from acrylamide, meth acrylamide, and their derivatives, 2-acrylamido-2-methyl-1-propanesulfonic acid, and its water soluble salts.

31. The aqueous dispersion as defined according to claim 23, comprising
a) 20 to 70% by weight styrene,
b) 20 to 60% by weight conjugated dienes,
c) 9 to 40% by weight itaconic or (meth)acrylic acid ester,
d) 0.01% to 5% by weight ethylenically unsaturated functional monomer,
in each case based on the total weight of the monomers,
wherein the functional monomer is selected from (meth)acrylic acid.

32. The aqueous dispersion as defined according to claim 23, comprising
a) 20 to 70% by weight styrene,
b) 20 to 60% by weight conjugated dienes,
c) 1 to 40% by weight itaconic or (meth)acrylic acid ester,
d) 0.01% to 5% by weight ethylenically unsaturated functional monomer,
in each case based on the total weight of the monomers,
wherein the functional monomer is selected from acrylamide, meth acrylamide, and their derivatives.

33. The aqueous dispersion as defined according to claim 23, wherein the copolymer is obtained by free radical polymerization in the presence a molecular weight regulator.

34. The aqueous dispersion as defined according to claim 33, wherein the molecular weight regulator is selected from the group consisting of mercaptans such as n-dodecylmercaptan, tertiary dodecyl mercaptan; cyclohexene; halogenated hydrocarbons such as chloroform, bromoform, carbon tetrachloride; alpha-methyl styrene and its dimer, and terpinolene.

35. The aqueous dispersion as defined according to claim 23, further comprising a crosslinker.

36. A redispersible polymer powder produced from the aqueous dispersion as defined according to claim 23.

37. A method for preparing waterproofing material, comprising at least one step of mixing an aqueous dispersion, comprising
i) a copolymer prepared by polymerization of ethylenically unsaturated monomers comprising styrene, conjugated dienes, itaconic or (meth)acrylic acid esters, and at least one ethylenically unsaturated functional monomer; wherein the ethylenically unsaturated functional monomer is selected from the group consisting of an ethylenically unsaturated monomer having an acid group or the corresponding anion thereof, an ethylenically unsaturated monomer having an amino, amido, ureido or N-heterocyclic group or protonated on the nitrogen, or alkylated ammonium derivatives thereof, and an ethylenically unsaturated monomer having a keto group; and
ii) an emulsifier system, wherein the emulsifier system comprises at least one nonionic emulsifier, anionic emulsifier, or cationic emulsifier,
or the redispersible polymer powder of claim 37 with at least one hydraulic binder or a filler.

38. A waterproofing material comprising an aqueous dispersion, comprising
i) a copolymer prepared by polymerization of ethylenically unsaturated monomers comprising styrene, conjugated dienes, itaconic or (meth)acrylic acid esters, and at least one ethylenically unsaturated functional monomer; wherein the ethylenically unsaturated functional monomer is selected from the group consisting of an ethylenically unsaturated monomer having an acid group or the corresponding anion thereof, an ethylenically unsaturated monomer having an amino, amido, ureido or N-heterocyclic group or protonated on the nitrogen, or alkylated ammonium derivatives thereof, and an ethylenically unsaturated monomer having a keto group; and
ii) an emulsifier system, wherein the emulsifier system comprises at least one nonionic emulsifier, anionic emulsifier, or cationic emulsifier,
or the redispersible polymer powder as defined according to claim 37, and at least one hydraulic binder or a filler.

39. A waterproofing material according to claim 38, wherein the content of the hydraulic binder may be from about 1 to 70% by weight, based on the total weight of the waterproofing material.

40. A waterproofing material, comprising
(i) 1-50% by weight hydraulic binder,
(ii) 40-77% by weight filler,
(iii) 10-40% by weight of the redispersible polymer powder according to claim 37, and
(iv) 0-5% by weight one or more additives,
in each case based on the weight of the waterproofing material.

41. A waterproofing material, comprising
(a) a dry component, comprising
(i) 1-50% by weight hydraulic binder,
(ii) 40-60% by weight filler, and
(iii) 0-5% by weight one or more additives,
in each case based on the weight of the total dry component, and
(b) a wet component, comprising
(i) 90-100% by weight of an aqueous dispersion as defined according to claim 23, and
(ii) optionally one or more additives,
in each case based on the weight of the total wet component,
and wherein the ratio of dry component (a) to wet component (b) is in the range of 4:1 to 1:2.

42. A waterproofing material composition according to claim 38, wherein the hydraulic binder is selected from a calcium silicate cement such as ordinary portland cement, calcium aluminate cement, calcium sulfate source, calcium sulfoaluminate cement, and further latent hydraulic materials and combinations thereof.
